(19) United States
(12) Patent Application Publication
(10) Pub. No.: US 2008/0044323 A1
(43) Pub. Date: Feb. 21, 2008

(54) Power generation system

(76) Inventor: Pete Rosas, Hialeah, FL (US)

Correspondence Address: John H. Faro, Esq.;FARO & ASSOCIATES, Suite 1100, 44 West Flagler Street, Miami, FL, 33130, US

(21) Appl. No.: 11/504,201

(22) Filed: Aug. 15, 2006

(51) Int. Cl. B01J 8/00

(52) U.S. Cl. 422/193

(57) ABSTRACT

A modular system for generation of acetylene gas, in a reactor suitable for the controlled reaction of calcium carbide and water, is disclosed. In this system, a self-container reactor module is provided which is suitable for coupling to an acetylene gas reservoir. In one of the preferred embodiments of this invention, this reactor module can include a primary and a secondary charge of calcium carbide, and a stoichiometric excess of water. Acetylene gas is formed by initial contact of a primary calcium carbide charge with water in the reactor reservoir. Upon essentially complete reaction of the primary charge and the water in the reservoir, the pressure within the reactor is monitored, as such gas is drawn off to fuel the operation of an internal combustion engine. Where such pressure drops to, or below a pre-determined level, a secondary charge of calcium carbide is contacted with the remaining water in the reactor reservoir, so as to prevent interruption in the fueling of the internal combustion engine. These modules can also be “daisy chained” together, and thereafter sequentially activated, to provide essentially continuous operation of an internal combustion engine.

### BACKGROUND OF THE INVENTION

1. Field of the Invention

The present invention relates to the field of power systems. More specifically, this invention relates to a system for generation of acetylene gas from calcium carbide, and the use thereof to fuel an internal combustion engine.

2. Prior Art

The present invention can be adapted to provide either mechanical or electrical power for both stationary and mobile systems. The preferred embodiments, however, are intended for use in mobile systems, such as in the powering of automobiles, trucks, fork lifts and other vehicles. As such, the prior art relating to power plants for such mobile systems and the fuels used therein will be discussed, it being understood however, that the present invention is not so limited in its application.

At the present time, the vast majority of vehicles in day-to-day operation utilize an internal combustion engine operating on some suitable hydrocarbon fuel. Of these, most operate on gasoline, while smaller numbers operate on diesel fuels and liquid propane gas (LPG). These fuels, however, are becoming increasingly expensive, are subject to supply limitations by foreign powers, and would appear to be nearly exhaustible in supply in the not too distant future. Accordingly, it would be desirable to develop other propulsion systems based on other fuels, or other sources of energy, more readily available and not as subject to control by foreign powers.

One type of propulsion energy, which attracted considerable interest in the early days of automobiles, and is the subject of substantial study at the present time, is electric power. However, since these early efforts, the rate of advance of the energy storage (battery) technology has been disappointing, and electric powered cars operating on batteries are currently highly limited in range and in recharging rate in comparison to the range of hydrocarbon fuel vehicles and the speed with which they may be refueled. Vehicles powered with electricity, however, have the advantage that the original or primary source of energy used to charge the batteries may be substantially anything, hydro-electric plants, fossil fuel burning plants, and nuclear power generating plants being the most common. Obviously, even solar energy is a potential source of power to recharge the batteries.

Other fuels have also been considered for use in vehicles, including hydrogen and acetylene. Hydrogen has the advantage of almost unlimited supply from water, and has a high energy content on a per pound basis, though poses difficult storage problems and substantial safety hazards. In essence, the concept is to use hydrogen as an energy containing medium for burning in a vehicle, thereby creating water vapor in the exhaust. The hydrogen would be generated at some remote power plant using coal, nuclear or other sources of energy, probably by the decomposition of water at that location. Such use of hydrogen as a fuel, however, has, in general, not proceeded beyond the very early experimental stages.

Acetylene, as previously mentioned, has also been proposed for use as a fuel for internal combustion engines. On a per pound basis, acetylene has a high energy content (higher than gasoline), and forms an explosive mixture with air over a wide range of mixing ratios. It also may be generated relatively easy from calcium carbide, a material which in itself is relatively safe and easily handled until mixed with water. As such, the safety hazard of carrying calcium carbide in a vehicle is probably substantially less than that of carrying gasoline, liquid propane or other fuels in their combustible state.

One prior art system for utilizing acetylene as a source of fuel in a mobile system is disclosed in U.S. Pat. No. 3,664,134. In that system, calcium carbide and water are combined in a reactor to form acetylene, which is then used as a fuel for a conventional internal combustion engine. The system of that patent also features as afterburner, and a calcium hydroxide scrubber for the engine exhaust for reduction of atmospheric pollutants. This system has the advantage of being operative with a conventional internal combustion engine; however, the acetylene generator has certain inefficiencies, in that apparently a large excess of water is required in the wet process for generating acetylene in the reactor in order to keep the reactor temperatures down. More importantly, all of the heat given off in the exothermic reaction between the calcium carbide and the water is lost, as there is no way to recover this heat in any useful manner for the system disclosed.

Another prior art system for utilizing acetylene as a source of fuel in a mobile system is disclosed in U.S. Pat. No. 4,257,232. This system passes the feed water through the reactor to cool the reactor and preheat the feed water before delivering the feed water to a boiler. While this recovers heat given off in the exothermic reaction between the calcium carbide and the water, energy is lost in the exhaust of the burner that heats the boiler, in the condensation of the exhaust steam and water from the steam expander, and in the dissociation of hydrogen and oxygen in the steam expander.

In each of the prior art systems referenced above, the generation of acetylene involves charging a reactor with a defined quantity of calcium carbide and the reaction thereof with a water. As the reaction proceeds, the calcium carbide is consumed, producing acetylene gas and calcium hydroxide. Depending upon the ambient reaction environment, approximately 230 to 280 liters of acetylene gas are produced from each kilogram of calcium carbide. The volume of fuel is sufficient to power a small internal combustion engine (fork lift engine) for approximately 3 to 5 days of routine industrial use. Upon exhaustion/consumption of the acetylene, the reactor is simply recharged with calcium carbide and water, and the acetylene gas supply regenerated. Notwithstanding the advantages inherent in the use of this fuel generation system, there still exists a need for further improvement, including specifically, the provision of means to simplify the replenishment of the acetylene regeneration system; and, to provide means to allow for sufficient availability of fuel to complete a task or operation without depletion thereof before the task is completed. Moreover, improvement is also needed for disposal of the residues remaining from the reaction of calcium carbide and water Calcium hydroxide).

### SUMMARY OF THE INVENTION

The above and related objects are achieved by providing a modular system for generation of acetylene gas in a reactor suitable for the controlled reaction of calcium carbide and water. In this system, a self-container reactor module is provided which is suitable for coupling to an acetylene gas reservoir. In practice, this reactor module can include one or more charges of calcium carbide, and a stoichiometric excess of water. Thus, upon consumption of a first charge of calcium carbide, a second (back-up) charge, within this reactor module, can be contacted with water, and thereby continue to generate acetylene gas, until such time as the reactor module can be replaced with a new module. Accordingly, unlike conventional propane powered vehicles, the passenger is not stranded upon exhaustion of the fuel supply. Moreover, when the reactor module is replaced and recycled, the reaction residues can be safely disposed or recycled.

In the preferred reactor module of this invention, there are at least two charges of calcium carbide provided, a primary charge and a secondary charge. The primary charge is intended, upon reaction with the water in the reactor, to supply sufficient fuel, to power the engine of a conveyance (e.g. industrial fork-lift) for 3-5 days of normal use. Upon exhaustion of this primary charge, the operator can simply expose the secondary charge to water within the same reactor module, and continue to generate acetylene fuel for an abbreviated period. The secondary calcium carbide charge is sufficient, at a minimum, to allow for the acetylene powered conveyance to return to a refueling station, where the reactor module can be replaced with a newly charged reactor module.

The operator of the conveyance is alerted to the need to activate the secondary charge by a simple sensing means, which measures the pressure of the acetylene gas in the reservoir. As pressure drops below a predetermined level, a sensor detects this change in pressure an alert (alarm buzzer, warning light, etc.) energized. The operator is thus given sufficient notice and time, to bring the conveyance to a stop at a safe location, and re-energize the reactor module with the secondary (back up) charge of calcium carbide.

The reactor module can also include additional sensors to provide a gauge of the acetylene fuel in reserve; and, adaptors for safely purging reactor residues prior to recharging with calcium carbide and water.

### BRIEF DESCRIPTION OF THE DRAWINGS

FIG. 1 is a block diagram of a power system which incorporates the reactor module of this invention.

FIG. 2 is perspective view of a reactor module of this invention.

FIG. 3 is a block diagram of plurality of reactor modules coupled, through a common manifold, to an acetylene gas tank used to supply fuel to an internal combustion engine.

### DETAILED DESCRIPTION OF THE INVENTION INCLUDING PREFERRED EMBODIMENTS

In the preferred embodiment of this invention, illustrated by the block diagram of FIG. 1, a reactor module (10) is depicted for interaction of calcium carbide and water, under acetylene generating condition, to form acetylene gas. This acetylene gas is use to fuel a power plant, including a mobile power plants. Optionally, the reactor module (10) can include a water jacket (12) for circulation of heated fluid from this module (10) to a heat dissipation means (14), such as a radiator; or, alternatively, to a water jacket (16) of an internal combustion engine (18), and thereby enhance the completeness of the combustion of the acetylene fuel burned in such engine. Unlike acetylene generating systems used in the past, the acetylene reactor (10) is modular, and designed to adapt to a variety of acetylene fuel powered systems.

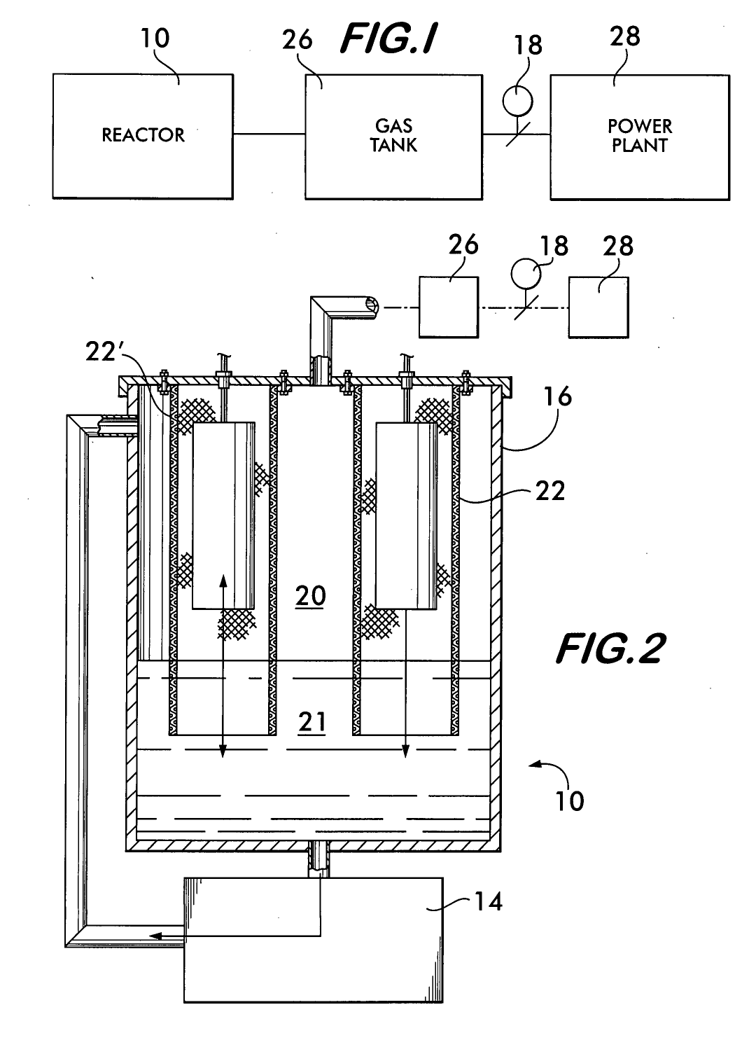

In the preferred embodiments of this invention, illustrated in FIG. 2, the reactor module (10) includes a water reservoir (20) and calcium carbide charging means (22, 22′). These calcium carbide charging means (22, 22′) are preferable isolatable from the water (21) in the reservoir (20), so as to preclude premature contact of the calcium carbide with water (21) in the reservoir (20), and with moisture that is present in the ambient environment. When acetylene fuel generation is desired, a calcium carbide charge means (22) (the primary charging means) is exposed to water (21) in the reservoir (20), and acetylene gas (24) generated. This exposure can be accomplished by immersion of the calcium carbide charging means (22, 22′) in the water (21) or, alternatively, pumping water (21) from the reservoir (20) onto the calcium carbide charge means. In the preferred embodiment of this invention, the calcium carbide charging means is contained a cage-like enclosure (filter), so as to permit the exposure of the contents thereof to water and yet retain particulates (unreacted solids) from filling up the reservoir (20). The gas (24) from this module (10) is allowed to flow into a gas tank (26), where it can be fed, under controlled pressure, to power plant (28) designed to run on acetylene gas (24), or on a mixture of acetylene (24) and another combustible fuel. Alternatively, the acetylene gas (24) can be combined with another combustible fuel before it is introduced into the engine combustion chamber.

In either case, a pressure control valve (28) is preferable between the gas tank (26) and the power plant (28) to restrict and meter the proper amount of acetylene gas (24) that is allowed to flow from the gas tank (26) to the combustion chamber of the power plant (28).

In order to avoid an unexpected, or interrupted supply, of acetylene gas (24) from the reactor module (10), the reactor module of this invention is supplied with at least two (2) means for admixture/contact of calcium carbide and water within the reactor, a primary charging means (22) and a secondary (backup) charging means (22′). Each of these charging means is distinct and separate from one another and, preferably, has separate and distinct activation means, for sequential introduction and/or contact of the contents thereof with water in the reactor reservoir (20). The volume of water in the reservoir (20) is proportioned relative to the combined amount of calcium carbide in both the primary and secondary charging means, and generally, such water is present in an amount in excess of that required to fully react with the aggregate amount of calcium carbide (also “stoichiometric excess”) in the primary (22) and secondary (22′) charging means.

In one of the preferred embodiments of this invention, the reactor module (10) of this invention is preferable comparable in size and weight to liquid propane tanks suitable for use in supply of fuel to a portable stove or grill, such as are found on boats and recreational vehicles.

Because of the exothermic reaction of the calcium carbide and water, the reactor is preferable thermally insulated to prevent burns from inadvertent contact. Alternatively, the reactor can be provided with cooling fins, or a water jacket, coupled to a radiator, to dissipate the heat from such reaction.

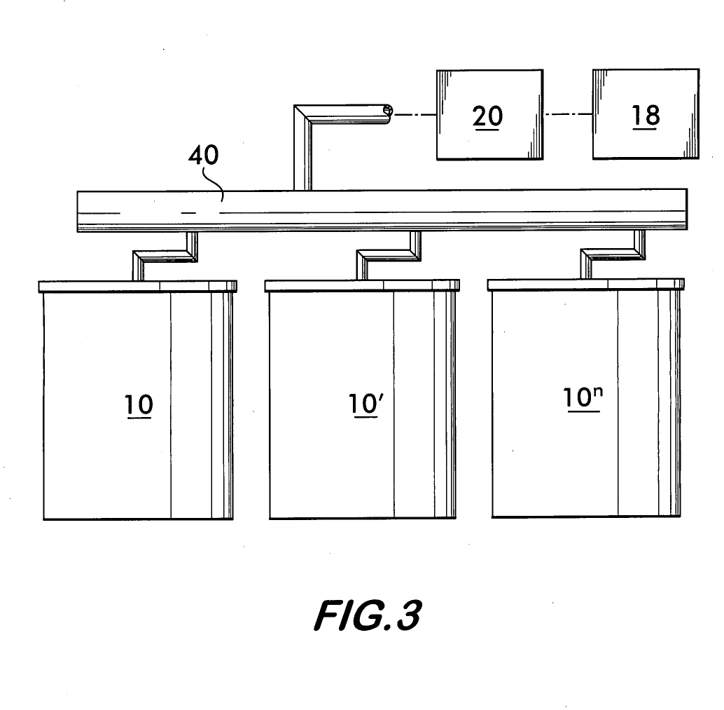

In another of the preferred embodiments of this invention, illustrated in FIG. 3, the reactor modules of this invention can be supplied in an assembly containing multiple reactor modules (10, 10′, 10″, 10ⁿ), all of which are coupled, through a common manifold (40), to an acetylene gas tank (20). Thus, as one reactor module (10) is exhausted, a replacement module (10′, 10″, 10ⁿ) can sequentially come on-line, to provide a continuous flow of acetylene to a power plant. Thereafter, the exhausted module is replaced at normal servicing intervals, without interruption in the operation of the power plant. This invention also includes a method of for providing an uninterrupted flow of fuel to an acetylene power plant.

What is claimed is:

1. In a reactor for generation of acetylene gas by combining calcium carbide and water, under acetylene forming conditions, wherein the improvement comprises:
(a) Providing a housing having a reservoir suitable for containment of water, under pressure;
(b) Means for injecting a primary calcium carbide charge into said reservoir, so as to react essentially all of said primary charge with water in said reservoir; and
(c) Means for injection a secondary charge of calcium carbide into said reservoir, so as to react essentially all of said secondary charge with water in said reservoir.

2. The improvement of claim 1, wherein said reactor is further provided with means for coupling said reservoir of said reactor to a power plant capable of running on acetylene gas.

3. The improvement of claim 1, wherein said reactor is further provided pressure sensing means for detection of acetylene gas pressure within said reservoir, and thereby detect changes in such acetylene gas pressure.

4. The improvement of claim 1, wherein said reactor is further provided with means for coupling said reservoir of said reactor to a power plant for a mobile conveyance.

5. The improvement of claim 1, wherein said reactor is further provided with means for coupling said reservoir of said reactor to a power plant for a stationary conveyance.

6. In a reactor for generation of acetylene gas by combining calcium carbide and water, under acetylene forming conditions, wherein the improvement comprises:
(a) Providing an array comprising a plurality of acetylene gas generator modules, each of said modules having a housing, which includes a reservoir suitable for containment of water, under pressure;
(b) Means for connection of each of said modules, in said array, to a common manifold;
(c) Means for coupling of said manifold to a power plant power plant capable of running on acetylene gas;
(d) Means for detection of changes in acetylene gas pressure within said manifold; and
(e) Means for sequentially initiating acetylene generation in each of said modules, in response to detection in pressure changes within said manifold.

7. The improvement of claim 6, wherein said manifold is further provided with pressure sensing means electrically coupled to solenoid, for sequentially activation of a calcium carbide charging means on an acetylene gas generation module within said array.

8. The improvement of claim 6, wherein said reactor is further provided pressure sensing means for detection of acetylene gas pressure within said reservoir, and thereby changes in such acetylene gas pressure.

9. The improvement of claim 6, wherein said reactor is further provided with means for coupling said reservoir of said reactor to a power plant for a mobile conveyance.

10. The improvement of claim 6, wherein said reactor is further provided with means for coupling said reservoir of said reactor to a power plant for a stationary conveyance.
